(19) United States
(12) Patent Application Publication
(10) Pub. No.: US 2008/0150903 A1
(43) Pub. Date: Jun. 26, 2008

(54) Electronic apparatus with dual-sided touch device

(75) Inventor: Chin-Jui Chuang, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/642,601

(22) Filed: Dec. 21, 2006

(51) Int. Cl. G06F 3/041

(52) U.S. Cl. 345/173

(57) ABSTRACT

An electronic apparatus with dual-sided touch device comprises a main body and a dual-sided touch device pivoted on the main body. The main body has a first case and a display panel disposed on one side surface of the first case. The dual-sided touch device has a second case and a dual-sided touch module disposed on the second case. In addition, the second case is pivoted on the first case. Also, the second case has two apertures in opposite directions. The second case can rotate relative to the first case and be against the first case to cover the display panel. Moreover, the dual-sided touch module has a light passable substrate and two light passable touch panels disposed on the two side surface of the substrate respectively. The two touch panels are exposed by the two apertures for sending a press signal and a track signal.

### BACKGROUND OF THE INVENTION

1. Field of Invention

The invention generally relates to a touch panel, and more particularly, to a dual-sided touch device and an electronic apparatus with a dual-sided touch device.

2. Related Art

Most of the portable electronic apparatuses such as tablet PC, notebook computer, personal digital assistant or smart phone have a touch panel for user to operate. The user may move the cursor on a screen to input a command. In addition, the touch panel may cooperate with software to recognize a moving track, so that the user may use a finger to proceed a manuscript input.

For text data inputting, lots of users are used to input the text data through keyboard. However, because the size of the portable device is limited, adding a keyboard on the device will cause inconvenience for the user. In addition, if a keyboard is integrated into the portable device, the weight and size of the portable device should be increased. Besides, the keyboard added into'the portable device may be too small in size or is improper for human-factors engineering. Moreover, for depositing a keyboard on a portable device, the size of the screen or touch panel of the portable device should be forced to reduce, which will cause more inconvenience for the user.

Because the functions of the touch panel and the keyboard are different and can't be replace with each other. Therefore, how to effectively integrate the touch panel and the keyboard into a portable device with an optimized design becomes an important technique issue.

### SUMMARY OF THE INVENTION

The object of the present invention is to provide an electronic apparatus with dual-sided touch device, which integrates a keyboard and a handwriting board or a touch panel, for improving the input interface of the portable electronic apparatus.

To achieve the object of the present invention, an electronic apparatus with dual-sided touch device is provided. It mainly comprises a main body and a dual-sided touch device pivoted on the main body. The main body includes a first case and a display panel, and the display panel is disposed on one side surface of the first case. In addition, the electronic apparatus with dual-sided touch device has a second case and a dual-sided touch module disposed on the second case. The second case is pivoted on the first case and has two apertures in opposite directions, wherein the second case can rotate relative to the first case and against the first case to cover the display panel. The dual-sided touch module has a substrate through which light can pass and two touch panels. Also, the two touch panels are also light passable. The two touch panels are disposed on two side surfaces and exposed through the two apertures. A user can touch the two touch panels to send a press signal and a track signal.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a sectional view of construction of a dual-sided touch module of the present invention;

FIG. 2 is a descriptive view of an electronic apparatus with dual-sided touch device in which the touch panel is in an opened position;

FIG. 3 is a descriptive view of an electronic apparatus dual-sided touch device in which the touch panel is in a closed position;

FIG. 4 is a descriptive view of an electronic apparatus with dual-sided touch device in which the touch panel further includes light-conductive elements that can be lighted up;

FIG. 5 is a descriptive view of an electronic apparatus with dual-sided touch device in which the touch panel further includes light-conductive elements that can be lighted up and a flexible thin film being pulled out;

FIG. 6 is a descriptive view of an electronic apparatus with dual-sided touch device in which a flexible thin film being retracted; and

FIG. 7 is a descriptive view of an electronic apparatus with dual-sided touch device in which a flexible thin film being pulled out.

### DETAILED DESCRIPTION OF THE INVENTION

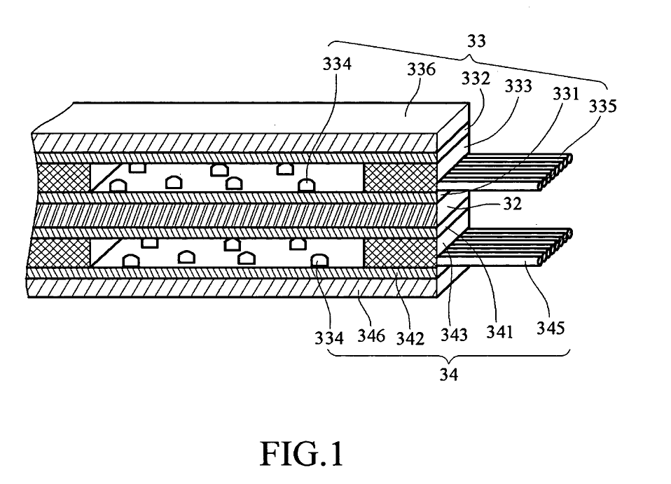

FIG. 1 is a sectional view of construction of a dual-sided touch module 30 of the present invention.

The dual-sided touch module 30 has a substrate through which light can pass, a first touch panel 33, a second touch panel 34. The substrate is made of a transparent material for light passing through. The first touch panel 33 and the second touch panel 34 are also light passable and disposed on the two side surfaces of the substrate 32. The user can touch the two touch panels 33, 34 to send a press signal and a track signal.

When the dual-sided touch module 30 is used, an image is projected from one side of the second touch panel 34, so that the image can be passed through the second touch panel 34, the substrate 32, and the first touch panel 33 sequentially. Then, the first touch panel 33 corresponding to the image performs the operation. Or, the dual-sided touch module 30 can be turned over. Therefore, the image is projected from one side of the first touch panel 33, and then the image passes through the first touch panel 33, the substrate 32, and the second touch panel 34. Then, the second touch panel 34 corresponding to the image performs the operation. The substrate 32 is used as a buffer in order to avoid the interference when the first touch panel 33 is touched and pressed, the second touch panel 34 may be simultaneously activated by the touch applied on the first touch panel 33. On the contrary, the substrate 32 is performed as a buffer in order to avoid the interference when the second touch panel 34 is being touched and pressed, the first touch panel 33 may be simultaneously activated by the touch applied on the second touch panel 34.

The first touch panel 33 and the second touch panel 34 may be a resistive touch panel. The first touch panel 33 has a first conductive layer 331 and a second conductive layer 332 parallel to the first conductive layer 331. The first conductive layer 331 and the second conductive layer 332 are connected and kept a distance with each other by a glue layer 333, wherein the second conductive layer 332 is located on the outer surface of the dual-sided touch module 30 for being touched, and the first conductive layer 331 is attached on one side surface of the substrate 32 for fixing the first touch panel 33 on the substrate 32. In addition, a plurality of spacers 334 is disposed between the first conductive layer 331 and the second conductive layer 332 to avoid the first conductive layer 331 and the second conductive layer 332 breaking resulted from a large deformation force caused by the touch. The first conductive layer 331 and the second conductive layer 332 may be made of a light passable material, such as Indium Tin Oxide (ITO). Moreover, the first touch panel 33 further includes a first wiring 335 and a first protective film 346, wherein the first wiring 335 electrically connects with the second conductive layer 332 for transmitting signals. And the first protective film 336 is attached on the outer surface of the second conductive layer 332 for protecting the second conductive layer 332 being worn out.

The structure of the second touch panel 34 is as same as that of the first touch panel 33. The second touch panel 34 has a third conductive layer 341 and a fourth conductive layer 342 parallel to the second touch panel 34. The third conductive layer 341 and the fourth conductive layer 342 are connected and kept a distance with each other by a glue layer 343, wherein the fourth conductive layer 342 is located on the outer surface of the dual-sided touch module 30 for being touched, and the third conductive layer 341 is attached on the other side surface of the substrate 32 for fixing the second touch panel 34 on the substrate 32. In addition, a plurality of spacers 344 is disposed between the third conductive layer 341 and the fourth conductive layer 342 to avoid the third conductive layer 341 and the fourth conductive layer 342 breaking resulted from a large deformation force caused by the touch. The third conductive layer 341 and the fourth conductive layer 342 may be made of a light passable material, such as Indium Tin Oxide (ITO). Moreover, the second touch panel 34 further includes a second wiring 345 and a second protective film 346, wherein the second wiring 345 electrically connects with the third conductive layer 341 for transmitting signals. And the second protective film 346 is attached on the outer surface of the fourth conductive layer 342 for protecting the fourth conductive layer 342 being worn out.

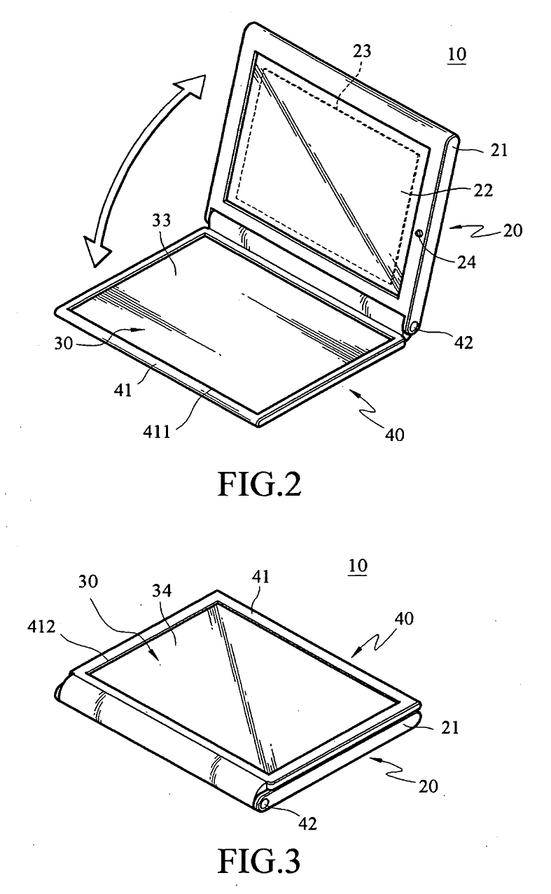

As shown in FIG. 2, it is a descriptive view of an electronic apparatus with dual-sided touch device in which the touch panel is in an opened position, and as shown in FIG. 3, it is a descriptive view of an electronic apparatus with dual-sided touch device in which the touch panel is in a closed position. The electronic apparatus with dual-sided touch device is an electronic apparatus 10 integrated with a dual-sided touch module 30 in order to provide the input function as keyboard, handwriting board or touch panel.

The electronic apparatus 10 comprises a main body 20 and a dual-sided touch device 40. The main body 20 includes a first case 21, a display panel 22, a control circuit 23, and a sensor 24, wherein the display panel 22 is disposed on one side surface of the first case, and the control circuit 23 is disposed on the first case 21 and electronically connects with the display panel 22 for receiving a display signal to drive the display. The sensor 24 is disposed on the first case 21 and located on the same side surface as the display panel 22 for sending a trigger signal to the control circuit 23.

A dual-sided touch device 40 includes a second case 41 and the mentioned dial-sided touch module 30, wherein the dual-sided touch module 30 electronically connects with the control circuit 23 of the main body 20. The second case 41 may form an included angle with the first case 21 of the main body 20 or be against the first case 21. In addition, in the opposite side surface of the second case 41, a first aperture 411 and a second aperture 412 are disposed thereon. The second case 41 may be pivoted on the first case 21 through a shaft 42; therefore, the second case 41 may rotate relative to the first case 21 and an included angle may form between the first case 21 and the second case 41. Or the second case 41 may be against the first case 21 to cover the display panel 22.

The dual-sided touch module 30 is disposed on the second case 41 so as to let the first touch panel 33 expose through the first aperture 411 and the second touch panel 34 expose through the second aperture 412; hence, the first touch panel 33 and the second touch panel 34 are disposed on the two side surfaces of the second case 41. When an included angle is formed between the second case 41 and the first case 21, the user may proceed a touch input through the first touch panel 33. However, when the second case 41 is against the first case 21, the direction of the first touch panel is toward the first case 21 and the display panel 22. In the mean time, the image displayed by the display panel 22 can pass through the dual-sided touch module 30 for the user to observe through the second touch panel 34. Then, the user may touch a selected icon through the second touch panel 34 or input a command so as to let the display panel 22 has a touch control function.

The sensor 24 is used to detect the position of the second case 41 relative to the position of the first case 21. When the second case 41 is far away from the first case 21, the sensor wouldn't detect the second case 41. At this time, the control circuit 23 may turn off the second touch panel 34 and turn on the first touch panel 33 for the user to input data through the first touch panel 33 and avoid the second touch panel 34 sending out an error input signal. On the other hand, when the second case 41 is against the first case 21, the sensor can detect the second case 41 and then send a trigger signal to the control circuit 23. The control circuit 23 turns off the first touch panel 33 and turns on the second touch panel 34. In the mean time, the user may observe the image displayed on the display panel 22 through the dual-sided touch device 30, and touch a selected icon on the display panel 22 through the second touch panel 34 for inputting.

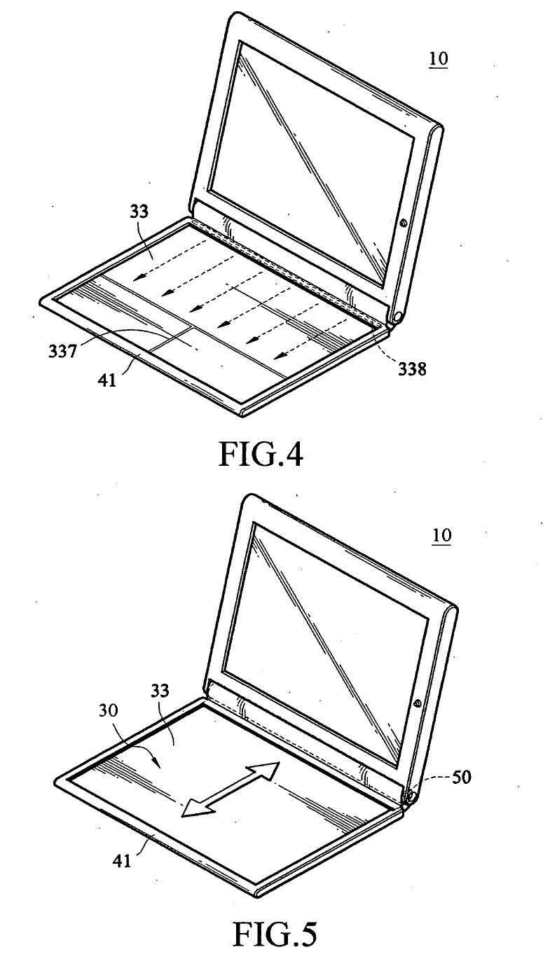

As shown in FIG. 4, it is a descriptive view of an electronic apparatus with dual-sided touch device in which the touch panel further includes light conductive elements that can be lighted up. In order to help the user clearly identifying different function regions on the first touch panel 33, there are light conductive elements 337 formed on the first touch panel 33 to divide the first touch panel 33 into a plurality of different regions. At least one light source 338 is disposed on the second case 41 relative to the first touch panel 33 and projects light along the outer side surface of the first touch panel 33 so as to let the light conductive elements 337 light-up after receiving the projecting light from the light source 338, so that a recognized effect is enhanced. In addition, through a software setting, the different regions of the first touch panel 33 may have owned different input functions.

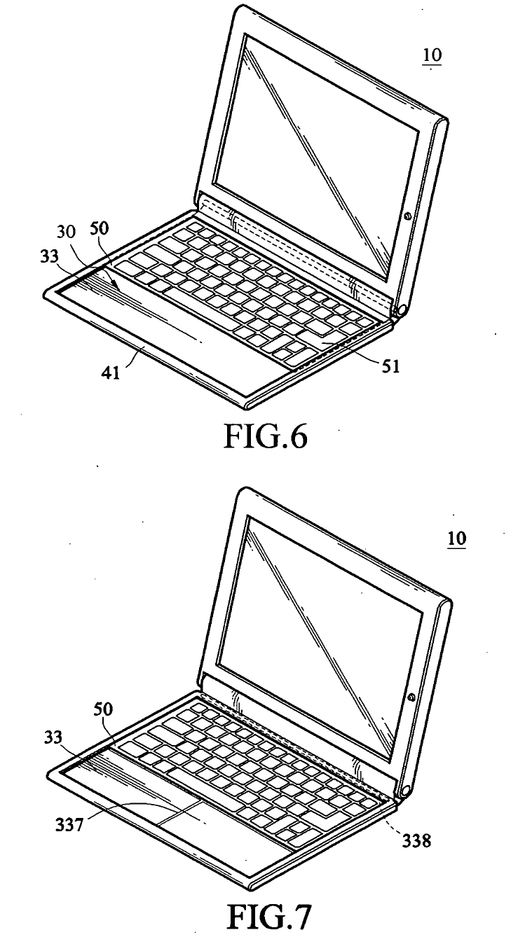

As shown in FIG. 5 and FIG. 6, they are an embodiment of the present invention. In order to let the dual-sided touch module 30 replace keyboard for inputting text data, a flexible thin film 50 is disposed on one side of the second case 41. The flexible thin film 50 is printed with a set of key patterns 51. When the keyboard function is no need, the flexible thin film 50 may be retracted on the second case 41. On the other hand, when the keyboard function is need, the flexible thin film 50 can be pulled out from the second case 41. Also, through a software setting, the regions on the first touch panel 33 corresponding to the set of key patterns 51 may be pressed and then the corresponding signal will be sent out, so that the first touch panel 33 may be used to replace a real keyboard.

As shown in FIG. 7, it is another embodiment of the present invention. In this embodiment, the light conductive elements 337 are formed on the first touch panel 33 and the light source 338 and the flexible thin film 50 are formed on the second case 41 so as to divide the first touch panel 33 into a plurality of different regions for different input functions. Therefore, the first touch panel 33 can be used to deal with different ways of input

The advantage of the present invention is that both side surfaces of the dual-sided touch device can be touched to perform an operation. Therefore, no matter the dual-sided touch device is against the main body or has an included angle with the main body, the user can utilize the dual-sided touch device to proceed a touch operation. In addition, depending on user's need, the dual-sided touch device can be used for the input of the press signal and the track signal, or the dual-sided touch device is against the display panel, so that the display panel can act as a keyboard to perform the touch function.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dual-sided touch module, comprising:
a substrate made of a transparent material; and
two touch panels, wherein the two touch panels are light passable and disposed on two side surfaces of the substrate respectively for sending a press signal and a track signal by way of a touch.

2. The dual-sided touch module as claimed in claim 1, wherein each touch panel has two conductive layers parallel to the touch panel, the two conductive layers keep a distance with each other, and one of the conductive layers is connected with the substrate.

3. The dual-sided touch module as claimed in claim 2, wherein a plurality of spacers is disposed between the two conductive layers.

4. The dual-sided touch module as claimed in claim 2, wherein the two conductive layers are made of a light passable material.

5. The dual-sided touch module as claimed in claim 4, wherein the light passable material is Indium Tin Oxide (ITO).

6. The dual-sided touch module as claimed in claim 2, wherein each touch panel further include a protective layer attached on outer side surface of the touch panel.

7. An electronic apparatus with dual-sided touch device, comprising:
a main body having a first case and a display panel disposed on one side surface of the first case; and
a dual-sided touch device, comprising:
a second case pivoted on the first case, wherein the second case has two apertures in opposite directions, and the second case can be rotated relative to the first case and against the first case to cover the display panel; and
a dual-sided touch module disposed on the second case, wherein the dual-sided touch module has a light passable substrate and two light passable touch panels disposed on the two side surfaces of the substrate respectively, the two touch panels are exposed by the two apertures for sending a press signal and a track signal by way of a touch.

8. The electronic apparatus with dual-sided touch device as claimed in claim 7, wherein the main body further includes a control circuit and a sensor, the control circuit electrically connects with the two touch panels and the sensor, the sensor is used to send a trigger signal to the control circuit from the first case when the second case is against the first case, and then the control circuit turns off the touch panel toward the first case and turns on the other touch panel.

9. The electronic apparatus with dual-sided touch device as claimed in claim 7, further comprising a light conductive element attached to one of the two touch panels for dividing the touch panel into a plurality of different regions.

10. The electronic apparatus with dual-sided touch device as claimed in claim 8, further comprising a light source disposed on the second case for projecting light along outer side surface of the touch panel so as to let the light conductive element light-up after receiving the projecting light from the light source.

11. The electronic apparatus with dual-sided touch device as claimed in claim 7, further comprising a flexible thin film printed with a plurality of key patterns, wherein the flexible thin film can be retracted on the second case or pulled out on one of the two touch panels.
